(19) United States
(12) Patent Application Publication
(10) Pub. No.: US 2020/0342812 A1
(43) Pub. Date: Oct. 29, 2020

(54) PIXEL DRIVING CIRCUIT, DRIVING METHOD THEREOF, DISPLAY DEVICE

(71) Applicants: Chengdu BOE Optoelectronics Technology Co., Ltd., Chengdu (CN); BOE Technology Group Co., Ltd., Beijing (CN)

(72) Inventor: Yingsong XU, Beijing (CN)

(21) Appl. No.: 16/330,529

(22) PCT Filed: May 18, 2018
(86) PCT No.: PCT/CN2018/087456

§ 371 Date: Mar. 5, 2019

(30) Foreign Application Priority Data
May 18, 2017 (CN) 201710352258.1

(51) Int. Cl. G09G 3/3258

(52) U.S. Cl. CPC G09G 3/3258; G09G 2320/0233; G09G 2330/021

(57) ABSTRACT

The present disclosure provides a pixel driving circuit, a driving method thereof, and a display device. The pixel driving circuit comprises: a driving transistor, an energy storage sub-circuit, a voltage maintenance sub-circuit, a data writing sub-circuit, a power supply control sub-circuit, and a reset compensation control sub-circuit. The energy storage sub-circuit is configured to store a threshold voltage of the driving transistor. The reset compensation control sub-circuit is configured to reset the driving transistor, the energy storage sub-circuit and the voltage maintenance sub-circuit in the reset phase responsive to a reset compensation control signal provided by the reset compensation control terminal, and to perform threshold voltage compensation on the driving transistor in the threshold compensation phase.

### RELATED APPLICATION

The present application claims the benefit of Chinese Patent Application No. 201710352258.1, filed on May 18, 2017, the entire disclosure of which is incorporated herein by reference.

### FIELD

The present disclosure relates to the field of display technologies, and especially to a pixel driving circuit, a driving method thereof, and a display device.

### BACKGROUND

An AMOLED (Active Matrix Organic Light-Emitting Diode) display has many advantages such as being self-illumination, ultra-thinness, fast response, high contrast, wide viewing angle, and the like, which is a display device having attracted considerable attention at present.

The AMOLED display includes a plurality of pixels arranged in a matrix, wherein driving and controlling each pixel for grayscale display depend on a pixel driving circuit inside the pixel. The pixel driving circuit mainly includes: a switching transistor, a capacitor, an OLED (Organic Light-Emitting Diode) light emitting device, and a driving transistor. In operation, the driving transistor in each pixel drives a corresponding OLED light emitting device to emit light to realize a self-luminous function of the AMOLED display.

However, driving transistors included in the AMOLED display have certain non-uniformity upon fabrication, so that threshold voltages of the driving transistors to which different pixels in the AMOLED display correspond are different. Therefore, in case the same data voltage is input to two driving transistors having different threshold voltages, driving currents generated by the two driving transistors in a saturated state are different, so that the OLED light emitting devices they respectively drive have different luminances, which in turn affects the uniformity in the display brightness of the AMOLED display.

### SUMMARY

In view of the above, an aspect of the present disclosure provides a pixel driving circuit comprising: a driving transistor, an energy storage sub-circuit, a voltage maintenance sub-circuit, a data writing sub-circuit, a power supply control sub-circuit, and a reset compensation control sub-circuit. A control terminal of the driving transistor is connected to a first node, a first terminal of the driving transistor is connected to a second node, a second terminal of the driving transistor is connected to a third node, and the driving transistor is configured to drive a light emitting sub-circuit to emit light. A first terminal of the energy storage sub-circuit is is connected to the first node, a second terminal of the energy storage sub-circuit is connected to a fourth node, and the energy storage sub-circuit is configured to store a threshold voltage of the driving transistor. A first terminal of the voltage maintenance sub-circuit is connected to a first level input terminal, a second terminal of the voltage maintenance sub-circuit is connected to the fourth node, and the voltage maintenance sub-circuit is configured to maintain a potential of the second terminal of the energy storage sub-circuit. The data writing sub-circuit is connected to a scan signal input terminal, a data signal input terminal and the fourth node, and is configured to write a data signal provided by the data signal input terminal to the fourth node under the control of a scan signal provided by the scan signal input terminal. The power supply control sub-circuit is connected to a power supply control terminal, a power supply signal input terminal and the third node, and is configured to provide a power supply signal provided by the power supply signal input terminal to the third node under the control of a power supply control signal provided by the power supply control terminal. The reset compensation control sub-circuit is connected to a reset compensation control terminal, a reference level input terminal and the first node, and is configured to reset the driving transistor, the energy storage sub-circuit and the voltage maintenance sub-circuit in a reset phase under the control of a reset compensation control signal provided by the reset compensation control terminal, and perform threshold voltage compensation on the driving transistor in a threshold compensation phase.

According to some embodiments of the present disclosure, the reset compensation control sub-circuit comprises a reset transistor and a compensation transistor, and the reset compensation control terminal comprises a reset control terminal and a compensation control terminal. A control terminal of the reset transistor is connected to the reset control terminal, a first terminal of the reset transistor is connected to the first node, and a second terminal of the reset transistor is connected to the reference level input terminal. A control terminal of the compensation transistor is connected to the compensation control terminal, a first terminal of the compensation transistor is connected to the fourth node, and a second terminal of the compensation transistor is connected to the third node.

According to some embodiments of the present disclosure, the reset transistor and the compensation transistor are of a same type, and the reset control terminal and the compensation control terminal are connected to a same signal terminal.

According to some embodiments of the present disclosure, the data writing sub-circuit comprises a writing control transistor, a control terminal of the writing control transistor being connected to the scan signal input terminal, a first terminal of the writing control transistor being connected to the fourth node, and a second terminal of the writing control transistor being connected to the data signal input terminal.

According to some embodiments of the present disclosure, the power supply control sub-circuit comprises a power supply control transistor, a control terminal of the power supply control transistor being connected to the power supply control terminal, a first terminal of the power supply control transistor being connected to the third node, and a second terminal of the power supply control transistor being connected to the power supply signal input terminal.

According to some embodiments of the present disclosure, the energy storage sub-circuit comprises an energy storage capacitor, a first end of the energy storage capacitor being connected to the first node, and a second end of the energy storage capacitor being connected to the fourth node.

According to some embodiments of the present disclosure, the voltage maintenance sub-circuit comprises a voltage stabilization capacitor, one iii end of the voltage stabilization capacitor being connected to the first level input terminal, and the other end of the voltage stabilization capacitor being connected to the fourth node.

According to some embodiments of the present disclosure, the above-described pixel driving circuit further comprises a light emission control sub-circuit. The light emission control sub-circuit is connected to a light emission control terminal, the second node and a second level input terminal, respectively, and configured to ensure that the light emitting sub-circuit only emits light in a light emitting phase under the control of a light emission control signal provided by the light emission control terminal.

According to some embodiments of the present disclosure, the light emission control sub-circuit comprises a light emission control transistor, a control terminal of the light emission control transistor being connected to the light emission control terminal, a first terminal of the light emission control transistor being connected to the second level input terminal, and a second terminal of the light emission control transistor being connected to the first terminal of the driving transistor.

According to some embodiments of the present disclosure, the light emitting sub-circuit comprises a light emitting device, an anode of the light emitting device being connected to the first terminal of the driving transistor, and a cathode of the light emitting device being connected to the second level input terminal.

Another aspect of the present disclosure provides a driving method for a pixel driving circuit, which is applied to any of the pixel driving circuits described above. The driving method comprises, during each display period,

in a reset phase, releasing, by the reset compensation control sub-circuit, residual charges in the energy storage sub-circuit and the voltage maintenance sub-circuit, and turning on the driving transistor;

in a threshold compensation phase, discharging the driving transistor by the reset compensation sub-circuit, and storing the threshold voltage of the driving transistor in the energy storage sub-circuit;

in a data writing phase, writing, by the data writing sub-circuit, a data signal to the energy storage sub-circuit;

in a light emitting phase, driving, by the driving transistor, the light emitting sub-circuit to emit light.

According to some embodiments of the present disclosure, the pixel driving circuit further comprises a light emission control sub-circuit, the driving method further comprises: ensuring, by the light emission control sub-circuit, that the light emitting sub-circuit does not emit light in at least one of the reset phase, the threshold compensation phase, and the data writing phase.

According to some embodiments of the present disclosure, the driving method further comprises a first buffer phase between the threshold compensation phase and the data writing phase.

According to some embodiments of the present disclosure, the driving method further comprises a second buffer phase between the data writing phase and the light emitting phase.

A further aspect of the present disclosure provides a display device comprising any of the pixel driving circuits described above.

### BRIEF DESCRIPTION OF THE DRAWINGS

The drawings described herein are used to provide a further understanding of the present disclosure and constitute a part of the present disclosure. Exemplary embodiments of the present disclosure and the description thereof are used for illustrating the present disclosure and do not constitute an undue limitation to the present disclosure. In the drawings:

FIG. 1 is a block diagram of a pixel driving circuit provided by an embodiment of the present disclosure;

FIG. 2 is a circuit configuration diagram of a pixel driving circuit provided by an embodiment of the present disclosure;

FIG. 3 is a control timing diagram of a pixel driving circuit provided by an embodiment of the present disclosure; and

FIGS. 4a-4d are equivalent circuit diagrams of a pixel driving circuit provided by an embodiment of the present disclosure in different phases during one driving period.

### DETAILED DESCRIPTION

In order to further illustrate the pixel driving circuit, the driving method thereof, and the display device provided by embodiments of the present disclosure, detailed description will be made below with reference to the accompanying drawings.

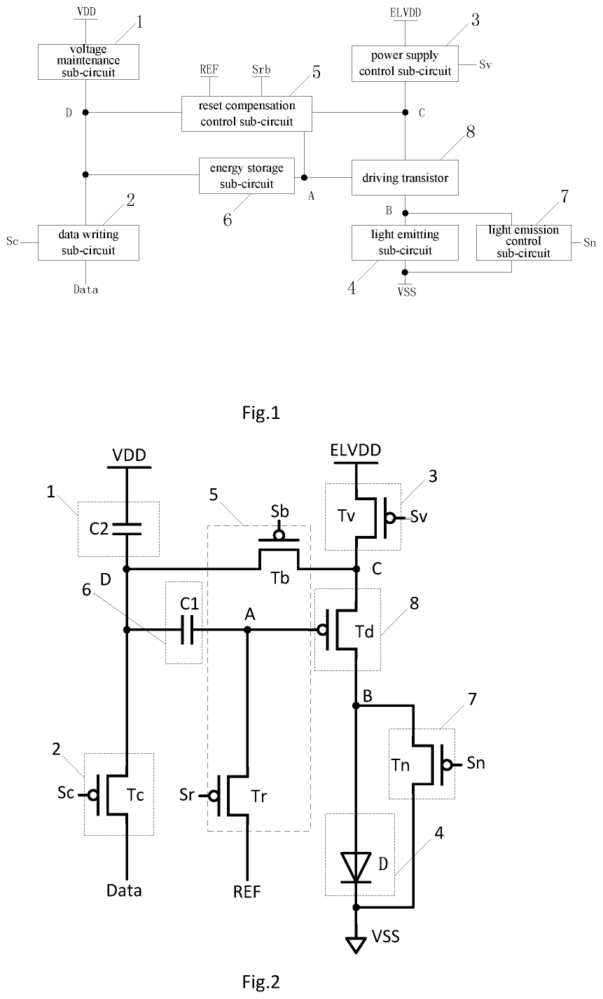

As shown in FIG. 1, a pixel driving circuit provided by an embodiment of the present disclosure comprises: a driving transistor Td, an energy storage sub-circuit 6, a voltage maintenance sub-circuit 1, a data writing sub-circuit 2, a power supply control sub-circuit 3, and a reset compensation control circuit 5. A control terminal of the driving transistor Td is connected to a first node A, a first terminal of the driving transistor Td is connected to a second node B, a second terminal of the driving transistor Td is connected to a third node C, and the driving transistor Td is configured to drive a light emitting sub-circuit 4 to emit light. A first terminal of the energy storage sub-circuit 6 is connected to the first node A, a second terminal of the energy storage sub-circuit 6 is connected to a fourth node D, and the energy storage sub-circuit 6 is configured to store a threshold voltage of the driving transistor Td. A first terminal of the voltage maintenance sub-circuit 1 is connected to a first level input terminal VDD, a second terminal of the voltage maintenance sub-circuit 1 is connected to the fourth node D, and the voltage maintenance sub-circuit 1 is configured to maintain a potential of the second terminal of the energy storage sub-circuit 6. The data writing sub-circuit 2 is connected to a scan signal input terminal Sc, a data signal input terminal Data and a fourth node D, and is configured to write a data signal provided by the data signal input terminal Data to the fourth node D under the control of a scan signal provided by the scan signal input terminal Sc. The power supply control sub-circuit 3 is connected to a power supply control terminal Sv, a power supply signal input terminal ELVDD and a third node C, and is configured to provide a power supply signal provided by the power supply signal input terminal ELVDD to the third node C under the control of a power supply control signal provided by the power supply control terminal Sv. The reset compensation control sub-circuit 5 is connected to a reset compensation control terminal Srb, a reference level input terminal REF and the first node A, and is configured to reset the driving transistor Td, the energy storage sub-circuit 6 and the voltage maintenance sub-circuit 1 in the reset phase under the control of a reset compensation control signal provided by the reset compensation control terminal Srb, and perform threshold voltage compensation on the driving transistor Td in the threshold compensation phase.

In the pixel driving circuit described above, the threshold voltage of the driving transistor is stored by the energy storage sub-circuit, and threshold voltage compensation is performed by the reset compensation control sub-circuit on the driving transistor in the threshold compensation phase, so that a driving current of the light emitting sub-circuit is only related to a power supply voltage and a data voltage, but unrelated to the threshold voltage of the driving transistor. Therefore, in case a same data voltage is input to a plurality of driving transistors having different threshold voltages, driving currents generated by the driving transistors having different threshold voltages in a saturated state are the same, so that corresponding light emitting sub-circuits have the same luminance, thereby avoiding the problem that the luminances of the light emitting sub-circuits are not uniform due to the threshold voltage drift.

In an exemplary embodiment, as shown in FIG. 1, the above pixel driving circuit may further comprise a light emission control sub-circuit 7. The light emission control sub-circuit 7 is connected to a light emission control terminal Sn, the second node B and a second level input terminal VSS, respectively, and is configured to ensure that the light emitting sub-circuit 4 only emits light in the light emitting phase under the control of a light emission control signal provided by the light emission control terminal Sn.

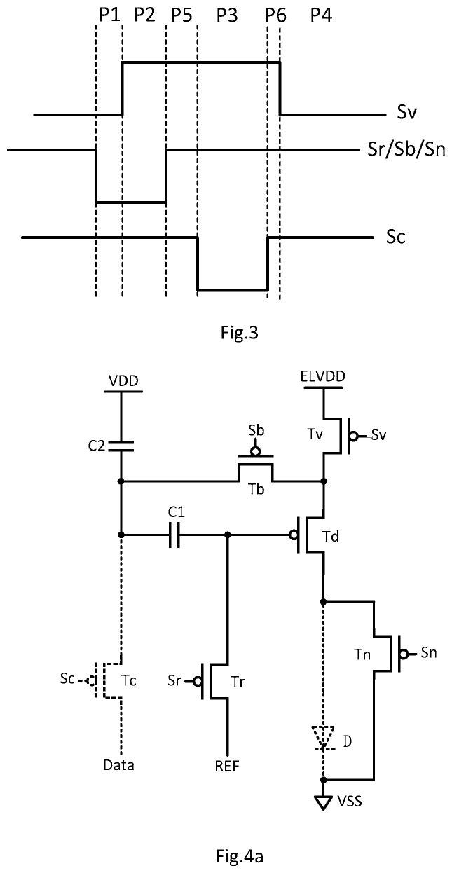

FIG. 2 illustrates a circuit configuration diagram of a pixel driving circuit provided by an embodiment of the present disclosure. As shown in FIG. 2, in an exemplary embodiment, the reset compensation control sub-circuit 5 comprises a reset transistor Tr and a compensation transistor Tb, and the reset compensation control terminal Srb includes a reset control terminal Sr and a compensation control terminal Sb. A control terminal of the reset transistor Tr is connected to the reset control terminal Sr, a first terminal of the reset transistor Tr is connected to the first node A, and a second terminal of the reset transistor Tr is connected to the reference level input terminal REF. A control terminal of the compensation transistor Tb is connected to the compensation control terminal Sb, a first terminal of the compensation transistor Tb is connected to the fourth node D, and a second terminal of the compensation transistor Tb is connected to the third node C.

In particular, when the reset transistor Tr and the compensation transistor Tb employ the same type of transistors (for example, both of which are P-type transistors or N-type transistors), control signals provided by the reset control terminal Sr and the compensation control terminal Sb may be the same control signal, that is, in this case, the reset control terminal Sr and the compensation control terminal Sb are connected to the same signal terminal, which can effectively reduce circuit traces and decrease circuit complexity.

In an exemplary embodiment, as shown in FIG. 2, the data writing sub-circuit 2 comprises a writing control transistor Tc. A control terminal of the writing control transistor Tc is connected to the scan signal input terminal Sc, a first terminal of the writing control transistor Tc is connected to the fourth node D, and a second terminal of the writing control transistor Tc is connected to the data signal input terminal Data.

In an exemplary embodiment, as shown in FIG. 2, the power supply control sub-circuit 3 comprises a power supply control transistor Tv. A control terminal of the power supply control transistor Tv is connected to the power supply control terminal Sv, a first terminal of the power supply control transistor Tv is connected to the third node C, and a second terminal of the power supply control transistor Tv is connected to the power supply signal input terminal ELVDD.

In an exemplary embodiment, as shown in FIG. 2, the energy storage sub-circuit 6 comprises an energy storage capacitor C1. A first end of the energy storage capacitor C1 is connected to the first node A, and a second end of the energy storage capacitor C1 is connected to the fourth node D.

In an exemplary embodiment, as shown in FIG. 2, the voltage maintenance sub-circuit 1 comprises a voltage stabilization capacitor C2. One end of the voltage stabilization capacitor C2 is connected to the first level input terminal VDD, and the other end of the voltage stabilization capacitor C2 is connected to the fourth node D.

In an exemplary embodiment, as shown in FIG. 2, when the pixel driving circuit comprises the light emission control sub-circuit 7, the light emission control sub-circuit 7 comprises a light emission control transistor Tn. A control terminal of the light emission control transistor Tn is connected to the light emission control terminal Sn, a first terminal of the light emission control transistor Tn is connected to the second level input terminal VSS, and a second terminal of the light emission control transistor Tn is connected to the first terminal of the driving transistor Td.

In an exemplary embodiment, as shown in FIG. 2, the light emitting sub-circuit 4 comprises a light emitting device D. The anode of the light emitting device D (for example, an organic light emitting diode) is connected to the first terminal of the driving transistor Td, and the cathode of the light emitting device is connected to the second level input terminal VSS.

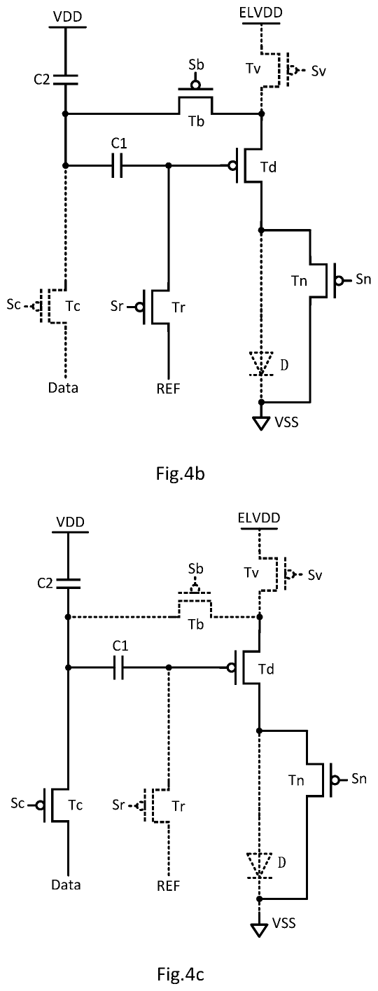

FIG. 3 illustrates a control timing diagram of the pixel driving circuit shown in FIG. 1.

In a reset phase P1, the power supply control terminal Sv provides a power supply control signal having an active level, the reset compensation control terminal Srb provides a reset compensation control signal having an active level, and the scan signal input terminal Sc provides a scan signal having an inactive level. At that time, the power supply control sub-circuit 3 provides the power supply signal provided by the power supply signal input terminal ELVDD to the second terminal of the driving transistor Td under the control of the power supply control signal. The reset compensation control sub-circuit 5 provides a reference level Vref provided by the reference level input terminal REF to the control terminal of the driving transistor Td under the control of the reset compensation control signal so that the driving transistor Td is turned on to prepare for the subsequent threshold compensation phase. The reset compensation control sub-circuit 5 further releases residual charges in the energy storage sub-circuit 6 and the voltage maintenance sub-circuit 1 under the control of the reset compensation signal, so that the energy storage sub-circuit 6 and the voltage maintenance sub-circuit 1 are reset, thereby initializing the pixel driving circuit.

As used herein, the term “active level” refers to a level that causes corresponding transistors to be turned on or causes corresponding sub-circuits to operate. For example, for N-type transistors, the active level is a high level. For P-type transistors, the active level is a low level. Accordingly, the term “inactive level” refers to a level that causes corresponding transistors to be turned off or causes corresponding sub-circuits not to operate. For example, for N-type transistors, the inactive level is a low level. For P-type transistors, the inactive level is a high level.

In a threshold compensation phase P2, the power supply control terminal Sv provides a power supply control signal having an inactive level, the reset compensation control terminal Srb provides a reset compensation control signal having an active level, and the scan signal input terminal Sc provides a scan signal having an inactive level. The reset compensation control sub-circuit 5 provides the reference level Vref provided by the reference level input terminal REF to the control terminal of the driving transistor Td under the control of the reset compensation control signal, so that the driving transistor Td continues to be turned on. Since the power supply control signal has an inactive level, the power supply control sub-circuit 3 does not provide a first level Vdd to the driving transistor Td, so that the driving transistor Td undergoes a discharging process and becomes turned off from being turned on. At the time of being turned off, the potential of the second terminal of the driving transistor Td changes from Vdd to Vref−Vth, where Vth is the threshold voltage of the driving transistor Td. The reset compensation control sub-circuit 5 connects the second terminal of the driving transistor Td to the second terminal of the energy storage sub-circuit 6 under the control of the reset compensation signal, so that the potential of the second terminal of the energy storage sub-circuit 6 also changes to Vref−Vth along with the second terminal of the driving transistor Td. It is to be noted that, when the driving transistor Td is undergoing the discharging process, the potential of the second terminal of the driving transistor Td starts to decrease from Vdd until it decreases to Vref−Vth which does not satisfy the turn-on condition of the driving transistor Td, so that the driving transistor Td is turned off.

In a data writing phase P3, the power supply control terminal Sv provides a power supply control signal having an inactive level, the reset compensation control terminal Srb provides a reset compensation control signal having an inactive level, and the scan signal input terminal Sc provides a scan signal having an active level. The data writing sub-circuit 2 writes the data signal Vdata provided by the data signal input terminal Data to the second terminal of the energy storage sub-circuit 6 under the control of the scan signal, so that the potential of the second terminal of the energy storage sub-circuit 6 changes from Vref−Vth to Vdata. The potential of the first terminal of the energy storage sub-circuit 6 changes from Vref to Vdata+Vth in response to the potential of the second terminal of the energy storage sub-circuit 6 changing from Vref−Vth to Vdata. Specifically, when the potential of the second terminal of the energy storage sub-circuit 6 changes from Vref−Vth to Vdata, the variation in the potential of the second terminal of the energy storage sub-circuit 6 is Vdata-(Vref−Vth). According to the law of charge conservation, the potential of the first terminal of the energy storage sub-circuit 6 should also have the same variation so that the potential of the control terminal of the driving transistor Td becomes Vref+Vdata−(Vref−Vth), that is, Vdata+Vth.

In a light emitting phase P4, the power supply control terminal Sv provides a power supply control signal having an active level, the reset compensation control terminal Srb provides a reset compensation control signal having an inactive level, and the scan signal input terminal Sc provides a scan signal having an inactive level. The power supply control sub-circuit 3 provides the power supply signal provided by the power supply signal input terminal ELVDD to the second terminal of the driving transistor Td under the control of the power supply control signal, so that the potential of the second terminal of the driving transistor Td changes from Vref−Vth to Vdd. Under the control of the voltage maintenance sub-circuit 1, the energy storage sub-circuit 6 maintains the potential of the second terminal at Vdata. Then, under the effect of the energy storage sub-circuit 6, the potential of the control terminal of the driving transistor Td is maintained at Vdata+Vth. Thus, the driving transistor Td is turned on under the control of both the potential Vdata+Vth of its control terminal and the potential Vdd of its second terminal, and generates a driving signal for driving the light emitting sub-circuit 4 to emit light, thereby driving the light emitting sub-circuit 4 to emit light.

According to the operating process of the pixel driving circuit during one driving period as described above, in the pixel driving circuit provided by an embodiment of the present disclosure, in the reset phase P1, residual charges in the energy storage sub-circuit 6 and the voltage maintenance sub-circuit 1 are released to turn on the driving transistor Td; in the threshold compensation phase P2, the driving transistor Td is subjected to a discharging process by controlling the potential of the second terminal of the driving transistor Td until the driving transistor Td is turned off, and the threshold voltage of the driving transistor Td is stored in the energy storage sub-circuit 6; in the data writing phase P3, the data signal is written to the second terminal of the energy storage sub-circuit 6, so that the potential of the second terminal of the energy storage sub-circuit 6 changes from Vref−Vth to Vdata, and the potential of the control terminal of the driving transistor Td jumps to Vdata+Vth under the effect of the energy storage sub-circuit 6; in the light emitting phase P4, the potential of the control terminal of the driving transistor Td is maintained at Vdata+Vth under the effect of the voltage maintenance sub-circuit 1, and the potential of the second terminal of the driving transistor Td becomes the supply voltage Vdd, so that the driving transistor Td is turned on. At that time, the voltage Vgs between the control terminal of the driving transistor Td and the second terminal of the driving transistor Td is:

Vgs=Vdata+Vth−Vdd, Equation 1

the driving current I generated by the driving transistor Td when it is turned on and operates in a saturated state is:

I=k(Vgs−Vth)² Equation 2

Equation 1 is substituted into Equation 2 to obtain:

I=k(Vdata+Vth−Vdd−Vth)²=k(Vdata−Vdd)² Equation 3

where k is a constant.

It can be seen from Equation 3 that the driving current I is only related to the power supply voltage Vdd and the data voltage Vdata, but is unrelated to the threshold voltage Vth of the driving transistor Td. Therefore, in case a same data voltage is input to a plurality of driving transistors Td having different threshold voltages Vth, driving currents generated by the driving transistors Td having different threshold voltages Vth in a saturated state are the same. Therefore, when the driving transistors Td having different threshold voltages Vth drive corresponding light emitting sub-circuits 4 to emit light, the light emitting sub-circuits 4 have the same luminance, thereby avoiding the problem that the luminances of the light emitting sub-circuits 4 are not uniform due to the threshold voltage drift when the driving transistors Td having different threshold voltages Vth are used to drive the light emitting sub-circuits 4 to emit light.

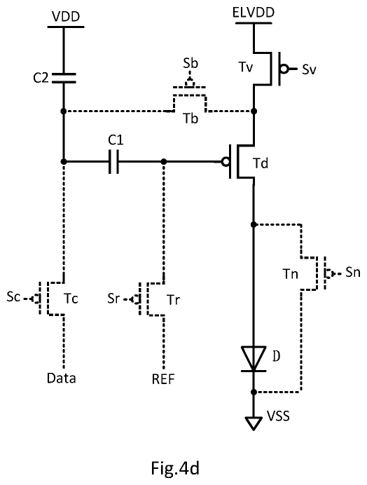

FIGS. 4a to 4d illustrate equivalent circuit diagrams of the pixel driving circuit shown in FIG. 2 in various phases.

As shown in FIG. 4a, in the reset phase P1, the reset transistor Tr is turned on under the control of the reset control signal provided by the reset control terminal Sr, so that the control terminal of the driving transistor Td is connected to the reference level input terminal REF. The compensation transistor Tb is turned on under the control of the compensation control signal provided by the compensation control terminal Sb so that the second terminal of the driving transistor Td is connected to the second end of the energy storage capacitor C1. The writing control transistor Tc is turned off under the control of the scan signal provided by the scan signal input terminal Sc, so that the second end of the energy storage capacitor C1 is disconnected from the data signal input terminal Data. The power supply control transistor Tv is turned on under the control of the power supply control signal provided by the power supply control terminal Sv, so that the second terminal of the driving transistor Td is connected to the power supply signal input terminal ELVDD. The voltage stabilization capacitor C2 stabilizes the voltage of the first end of the energy storage capacitor C1 and the voltage of the control terminal of the driving transistor Td through the energy storage capacitor C1, thereby avoiding display abnormality caused by external disturbance.

As shown in FIG. 4b, in the threshold compensation phase P2, the reset transistor Tr is turned on under the control of the reset control signal provided by the reset control terminal Sr, so that the control terminal of the driving transistor Td is connected to the reference level input terminal REF. The compensation transistor Tb is turned on under the control of the compensation control signal provided by the compensation control terminal Sb so that the second terminal of the driving transistor Td is connected to the second end of the energy storage capacitor C1. The writing control transistor Tc is turned off under the control of the scan signal provided by the scan signal input terminal Sc, so that the second end of the energy storage capacitor C1 is disconnected from the data signal input terminal Data. The power supply control transistor Tv is turned off under the control of the power supply control signal provided by the power supply control terminal Sv, so that the second terminal of the driving transistor Td is disconnected from the power supply signal input terminal ELVDD. The voltage stabilization capacitor C2 stabilizes the voltage of the first end of the energy storage capacitor C1 and the voltage of the control terminal of the driving transistor Td through the energy storage capacitor C1, thereby avoiding display abnormality caused by external disturbance.

As shown in FIG. 4c, in the data writing phase P3, the reset transistor Tr is turned off under the control of the reset control signal provided by the reset control terminal Sr, so that the control terminal of the driving transistor Td is disconnected from the reference level input terminal REF. The compensation transistor Tb is turned off under the control of the compensation control signal provided by the compensation control terminal Sb, so that the second terminal of the driving transistor Td is disconnected from the second end of the energy storage capacitor C1. The writing control transistor Tc is turned on under the control of the scan signal provided by the scan signal input terminal Sc, so that the second end of the energy storage capacitor C1 is connected to the data signal input terminal Data. The power supply control transistor Tv is turned off under the control of the power supply control signal provided by the power supply control terminal Sv, so that the second terminal of the driving transistor Td is disconnected from the power supply signal input terminal ELVDD. The voltage stabilization capacitor C2 stabilizes the voltage of the first end of the energy storage capacitor C1 and the voltage of the control terminal of the driving transistor Td through the energy storage capacitor C1, thereby avoiding display abnormality caused by external disturbance.

As shown in FIG. 4d, in the light emitting phase P4, the reset transistor Tr is turned off under the control of the reset control signal provided by the reset control terminal Sr, so that the control terminal of the driving transistor Td is disconnected from the reference level input terminal REF. The compensation transistor Tb is turned off under the control of the compensation control signal provided by the compensation control terminal Sb, so that the second terminal of the driving transistor Td is disconnected from the second end of the energy storage capacitor C1. The writing control transistor Tc is turned off under the control of the scan signal provided by the scan signal input terminal Sc, so that the second end of the energy storage capacitor C1 is disconnected from the data signal input terminal Data. The power supply control transistor Tv is turned on under the control of the power supply control terminal Sv, so that the second terminal of the driving transistor Td is connected to the power supply signal input terminal ELVDD. Since the second end of the energy storage capacitor C1 is in a floating state, the second end of the energy storage capacitor C1 is connected to the voltage stabilization capacitor C2, and the other end of the voltage stabilization capacitor C2 is connected to the first level input terminal VDD, the potential of the second end of the energy storage capacitor C1 is maintained. The first end of the energy storage capacitor C1 is in turn connected to the control terminal of the driving transistor Td, thereby ensuring that the control terminal of the driving transistor Td is not in a floating state.

When the pixel driving circuit comprises the light emission control sub-circuit 7, and the light emission control sub-circuit 7 comprises the light emission control transistor Tn, in the reset phase P1, the threshold compensation phase P2, and the data writing phase P3, the light emission control transistor Tn is turned on under the control of the light emission control signal provided by the light emission control terminal Sn, so that the first terminal of the driving transistor Td is connected to the second level input terminal VSS, thereby short-circuiting the light emitting device D. In the light emitting phase P4, the light emission control transistor Tn is turned off under the control of the light emission control signal provided by the light emission control terminal Sn, so that the first terminal of the driving transistor Td is disconnected from the second level input terminal VSS, thereby enabling the light emitting device D to normally emit light under the driving of the driving transistor Td.

Alternatively, the cathode of the light emitting device D and the first terminal of the light emission control transistor Tn may not be connected to the same terminal (the second level input terminal VSS), as long as the light emitting function of the light emitting device D and the short-circuit function of the light emission control transistor Tn can be satisfied.

It is to be noted that, in case the light emission control transistor Tn, the reset transistor Tr and the compensation transistor Tb employ the same type of transistors (all of which are P-type transistors or N-type transistors), the above light emission control terminal Sn may be provided with the same control signal as the reset control terminal Sr and the compensation control terminal Sb to ensure that the light emission control terminal Sn can control the light emission control transistor Tn to be turned on in the reset phase P1 and the threshold compensation phase P2, thereby enabling the light emitting sub-circuit 4 not to emit light in the reset phase P1 and the threshold compensation phase P2. Moreover, by providing the light emission control terminal Sn with the same control signal as the reset control terminal Sr and the compensation control terminal Sb, the light emission control terminal Sn, the reset control terminal Sr and the compensation control terminal Sb can be connected to a same control signal output terminal, thereby effectively reducing circuit traces.

In the data writing phase P3, the potential of the control terminal of the driving transistor Td is Vdata+Vth, and the potential of the second terminal of the driving transistor Td is Vref−Vth. In order to ensure that the light emitting sub-circuit 4 does not emit light in this phase, the driving transistor Td may be controlled to not satisfy the turn-on condition, that is, making (Vdata+Vth)−(Vref−Vth) smaller than the threshold voltage Vth of the driving transistor Td. Therefore, a suitable reference voltage Vref may be set as required to ensure that the light emitting sub-circuit 4 does not emit light in the data writing phase P3.

It is to be noted that the first level provided by the first level input terminal VDD needs to be a stable potential. Optionally, the first level provided by the first level input terminal VDD may be the power supply voltage Vdd. Thus, the first level input terminal may be directly connected to the power supply signal input terminal ELVDD, which avoids introducing an additional circuit for providing the first level, and reduces the area occupied by the pixel driving circuit. This is more advantageous for increasing the number of pixels of the display device and improving the display effect of the display device. Of course, the first level input terminal may also be connected to the reference voltage input terminal REF or the low level output terminal VSS, but it is not so limited. It is to be noted that the operating process of the provided pixel driving circuit is described in this embodiment only taking the specific circuit structure shown in FIG. 2 as an example. In other embodiments of the present disclosure, the voltage maintenance sub-circuit 1, the data writing sub-circuit 2, the power supply control sub-circuit 3, the light emitting sub-circuit 4, the reset compensation control sub-circuit 5, the energy storage sub-circuit 6 and the light emission control sub-circuit 7 of the pixel driving circuit each may be implemented in other configurations, which will not be described in detail herein. Besides, the above-described pixel driving circuit employs a smaller number of devices, so the area occupied by the pixel driving circuit is small, which is more advantageous for increasing the number of pixels of the display device and improving the display effect of the display device. In addition, the above transistors may all employ a thin film transistor, a field effect transistor or other devices having the same characteristics. In embodiments of the present disclosure, in order to distinguish two terminals of a transistor except the control terminal, one of them is referred to as a first terminal, and the other is referred to as a second terminal. In actual operations, the first terminal may be a drain, and the second terminal may be a source; or the first terminal may be a source, and the second terminal may be a drain.

In this embodiment, description is made based on an example in which the transistors are all P-type transistors, the first terminal is a drain and the second terminal is a source. One or more of the above transistors may also be N-type transistors without departing from the scope of the present disclosure. In addition, control signals provided by the power supply control terminal Sv, the light emission control terminal Sn, the reset control terminal Sr and the compensation control terminal Sb, a scan signal provided by the scan signal input terminal Sc, and a data signal provided by the data signal input terminal Data may all be pulse signals. A power supply signal provided by the power supply signal input terminal ELVDD, a second level signal provided by the second level input terminal VSS (which may be connected to the negative terminal of the power supply, but it is not so limited), and a reference signal provided by the reference level input terminal REF may all be DC signals.

An embodiment of the present disclosure further provides a driving method for a pixel driving circuit, which is applied to the above-described pixel driving circuit. Specifically, during each display period, the driving method comprises:

in the reset phase, releasing, by the reset compensation control sub-circuit, residual charges in the energy storage sub-circuit and the voltage maintenance sub-circuit, and turning on the driving transistor;

in the threshold compensation phase, discharging the driving transistor by the reset compensation sub-circuit, and storing the threshold voltage of the driving transistor in the energy storage sub-circuit;

in the data writing phase, writing a data signal to the energy storage sub-circuit by the data writing sub-circuit;

in the light emitting phase, driving the light emitting sub-circuit by the driving transistor to emit light.

Specifically, in the reset phase P1, the power supply control terminal Sv provides a power supply control signal having an active level, the reset compensation control terminal Srb provides a reset compensation control signal having an active level, and the scan signal input terminal Sc provides a scan signal having an inactive level. At that time, the power supply control sub-circuit 3 provides the power supply signal provided by the power supply signal input terminal ELVDD to the second terminal of the driving transistor Td under the control of the power supply control signal. The reset compensation control sub-circuit 5 provides the reference level Vref provided by the reference level input terminal REF to the control terminal of the driving transistor Td under the control of the reset compensation control signal so that the driving transistor Td is turned on to prepare for the subsequent threshold compensation phase. The reset compensation control sub-circuit 5 further releases residual charges in the energy storage sub-circuit 6 and the voltage maintenance sub-circuit 1 under the control of the reset compensation signal, so that the energy storage sub-circuit 6 and the voltage maintenance sub-circuit 1 are reset, thereby initializing the pixel driving circuit.

In the threshold compensation phase P2, the power supply control terminal Sv provides a power supply control signal having an inactive level, the reset compensation control terminal Srb provides a reset compensation control signal having an active level, and the scan signal input terminal Sc provides a scan signal having an inactive level. The reset compensation control sub-circuit 5 provides the reference level Vref provided by the reference level input terminal REF to the control terminal of the driving transistor Td under the control of the reset compensation control signal, so that the driving transistor Td continues to be turned on. Since the power supply control signal has an inactive level, the power supply control sub-circuit 3 does not provide the first level Vdd to the driving transistor Td, so that the driving transistor Td undergoes a discharging process and becomes turned off from being turned on. At the time of being turned off, the potential of the second terminal of the driving transistor Td changes from Vdd to Vref−Vth, wherein Vth is the threshold voltage of the driving transistor Td. The reset compensation control sub-circuit 5 connects the second terminal of the driving transistor Td to the second terminal of the energy storage sub-circuit 6 under the control of the reset compensation signal, so that the potential of the second terminal of the energy storage sub-circuit 6 also changes to Vref−Vth along with the second terminal of the driving transistor Td. It is to be noted that, when the driving transistor Td is undergoing the discharging process, the potential of the second terminal of the driving transistor Td starts to decrease from Vdd until it decreases to Vref−Vth which does not satisfy the turn-on condition of the driving transistor Td, so that the driving transistor Td is turned off.

In the data writing phase P3, the power supply control terminal Sv provides a power supply control signal having an inactive level, the reset compensation control terminal Srb provides a reset compensation control signal having an inactive level, and the scan signal input terminal Sc provides a scan signal having an active level. The data writing sub-circuit 2 writes the data signal Vdata provided by the data signal input terminal Data to the second terminal of the energy storage sub-circuit 6 under the control of the scan signal, so that the potential of the second terminal of the energy storage sub-circuit 6 changes from Vref−Vth to Vdata. The potential of the first terminal of the energy storage sub-circuit 6 changes from Vref to Vdata+Vth in response to the potential of the second terminal of the energy storage sub-circuit 6 changing from Vref−Vth to Vdata. Specifically, when the potential of the second terminal of the energy storage sub-circuit 6 changes from Vref−Vth to Vdata, the variation in the potential of the second terminal of the energy storage sub-circuit 6 is Vdata-(Vref−Vth). According to the law of charge conservation, the potential of the first terminal of the energy storage sub-circuit 6 should also have the same variation so that the potential of the control terminal of the driving transistor Td changes to Vref+Vdata-(Vref−Vth), that is, Vdata+Vth.

In the light emitting phase P4, the power supply control terminal Sv provides a power supply control signal having an active level, the reset compensation control terminal Srb provides a reset compensation control signal having an inactive level, and the scan signal input terminal Sc provides a scan signal having an inactive level. The power supply control sub-circuit 3 provides the power supply signal provided by the power supply signal input terminal ELVDD to the second terminal of the driving transistor Td under the control of the power supply control signal, so that the potential of the second terminal of the driving transistor Td changes from Vref−Vth to Vdd. Under the control of the voltage maintenance sub-circuit 1, the potential of the second terminal of the energy storage sub-circuit 6 is maintained at Vdata. Then, the potential of the control terminal of the driving transistor Td is maintained at Vdata+Vth under the effect of the energy storage sub-circuit 6. Thus, the driving transistor Td is turned on under the control of both the potential Vdata+Vth of its control terminal and the potential Vdd of its second terminal, and generates a driving signal for driving the light emitting sub-circuit 4 to emit light, thereby driving the light emitting sub-circuit 4 to emit light.

In the above-described driving method for a pixel driving circuit as provided by an embodiment of the present disclosure, in the reset phase P1, residual charges in the energy storage sub-circuit 6 and the voltage maintenance sub-circuit 1 are released, and the driving transistor Td is turned on; in the threshold compensation phase P2, the driving transistor Td is subjected to a discharging process by controlling the potential of the second terminal of the driving transistor Td until the driving transistor Td is turned off, and the threshold voltage of the driving transistor Td is stored in the energy storage sub-circuit 6; in the data writing phase P3, a data signal is written to the second terminal of the energy storage sub-circuit 6, so that the potential of the second terminal of the energy storage sub-circuit 6 changes from Vref−Vth to Vdata, and the potential of the control terminal of the driving transistor Td jumps to Vdata+Vth under the effect of the energy storage sub-circuit 6; in the light emitting phase P4, under the effect of the voltage maintenance sub-circuit 1, the potential of the control terminal of the driving transistor Td is maintained at Vdata+Vth, and the potential of the second terminal of the driving transistor Td changes to the power supply voltage Vdd, so that the driving transistor Td is turned on. At that time, the driving current I generated by the driving transistor Td when operating in a saturated state is: I=k(Vgs−Vth)², where k is a constant.

Therefore, the driving current I generated by the driving transistor Td is only related to the power supply voltage Vdd and the data voltage Vdata, but unrelated to the threshold voltage Vth of the driving transistor Td. Therefore, in case a same data voltage is input to a plurality of driving transistors Td having different threshold voltages Vth, driving currents generated by the driving transistors Td having different threshold voltages Vth in a saturated state are the same. Therefore, in case the driving transistors Td having different threshold voltages Vth drive corresponding light emitting sub-circuits 4 to emit light, the light emitting sub-circuits 4 have the same luminance, which thus avoids the problem that the luminances of the light emitting sub-circuits 4 are not uniform due to the threshold voltage drift when the driving transistors Td having different threshold voltages Vth are used to drive the light emitting sub-circuits 4 to emit light.

When proceeding to the data writing phase P3 from the threshold compensation phase P2, the control signal provided by the reset compensation control terminal Srb (including the reset control terminal Sr and the compensation control terminal Sb) jumps (from the second level to the first level, as shown in FIG. 3), and at the same time, the scan signal provided by the scan signal input terminal Sc also jumps (from the first level to the second level, as shown in FIG. 3). In order to avoid crosstalk caused by simultaneous jumps of the two signals, in an exemplary embodiment, a first buffer phase P5 may be introduced between the threshold compensation phase P2 and the data writing phase P3, that is, after the threshold compensation phase P2, when the reset compensation control signal changes from the second level to the first level, it proceeds to the first buffer phase P5. At the end of the first buffer phase P5, it proceeds to the data writing phase P3, at which time the scan signal is controlled to change from the first level to the second level. This not only ensures the operating process of the pixel driving circuit, but also avoids signal crosstalk caused by simultaneous jumps of different signals.

Similarly, when proceeding to the light emitting phase P4 from the data writing phase P3, the scan signal provided by the scan signal input terminal Sc jumps (from the second level to the first level, as shown in FIG. 3), and at the same time, the power supply control signal provided by the power supply control terminal Sv jumps (from the first level to the second level, as shown in FIG. 3). In order to avoid crosstalk caused by simultaneous jumps of the two signals, in an exemplary embodiment, a second buffer phase P6 may be introduced between the data writing phase P3 and the light emitting phase P4, that is, after the data writing phase P3, when the scan signal changes from the second level to the first level, it proceeds to the second buffer phase P6. At the end of the second buffer phase P6, it proceeds to the light emitting phase P4, at which time the power supply control signal is controlled to change from the first level to the second level. This not only ensures the operating process of the pixel driving circuit, but also avoids signal crosstalk caused by simultaneous jumps of different signals.

In an exemplary embodiment, when the pixel driving circuit provided by the above embodiment further comprises the light emission control sub-circuit 7, the above-described driving method for a pixel driving circuit further comprises: in the reset phase P1, the threshold compensation phase P2, and/or the data writing phase P3, ensuring, by the light emission control sub-circuit, the light emitting sub-circuit 4 not to emit light.

The various embodiments in this specification are described in a progressive manner, and the same or similar parts between the various embodiments may be referred to each other. In particular, for method embodiments, since they are basically similar to product embodiments, the description thereof is relatively simple, and relevant parts may be referred to the description of the product embodiments.

An embodiment of the present disclosure further provides a display device comprising the pixel driving circuit described above. In the display device, in case a same data voltage is input to a plurality of driving transistors Td having different threshold voltages Vth, driving currents generated by the driving transistors Td having different threshold voltages Vth in a saturated state are the same. Therefore, when the driving transistors Td having different threshold voltages Vth drive corresponding light emitting sub-circuits 4 to emit light, the light emitting sub-circuits 4 have the same luminance, which thus avoids the problem that the luminances of the light emitting sub-circuits 4 are not uniform due to the threshold voltage drift when the driving transistors Td having different threshold voltages Vth are used to drive the light emitting sub-circuits 4 to emit light, thereby ensuring the display quality of the display device.

The display device provided by this embodiment may be any product or component having a display function such as an OLED (organic light-emitting diode) panel, a mobile phone, a tablet computer, a television, a display, a notebook computer, a digital photo frame, a navigator, and the like.

In the description of the above embodiments, specific features, structures, materials or characteristics may be combined in a suitable manner in any one or more embodiments or examples.

What have been described above are only specific embodiments of the present disclosure, but the protection scope of the present disclosure is not so limited. Any variations or substitutions that can be readily conceived by the skilled person familiar with this technical field shall be encompassed within the protection scope of the present disclosure. Therefore, the protection scope of the present disclosure shall be determined based on the scope of the claims.

1. A pixel driving circuit comprising:
a driving transistor;
an energy storage sub-circuit;
a voltage maintenance sub-circuit;
a data writing sub-circuit;
a power supply control sub-circuit; and
a reset compensation control sub-circuit,
wherein a control terminal of the driving transistor is connected to a first node, a first terminal of the driving transistor is connected to a second node, a second terminal of the driving transistor is connected to a third node, and the driving transistor is configured to drive a light emitting sub-circuit to emit light,
wherein a first terminal of the energy storage sub-circuit is connected to the first node, a second terminal of the energy storage sub-circuit is connected to a fourth node, and the energy storage sub-circuit is configured to store a threshold voltage of the driving transistor,
wherein a first terminal of the voltage maintenance sub-circuit is connected to a first level input terminal, a second terminal of the voltage maintenance sub-circuit is connected to the fourth node, and the voltage maintenance sub-circuit is configured to maintain a potential of the second terminal of the energy storage sub-circuit,
wherein the data writing sub-circuit is connected to a scan signal input terminal, a data signal input terminal and the fourth node, and is configured to write a data signal provided by the data signal input terminal to the fourth node responsive to a scan signal provided by the scan signal input terminal,
wherein the power supply control sub-circuit is connected to a power supply control terminal, a power supply signal input terminal and the third node, and is configured to provide a power supply signal provided by the power supply signal input terminal to the third node responsive to a power supply control signal provided by the power supply control terminal, and
wherein the reset compensation control sub-circuit is connected to a reset compensation control terminal, a reference level input terminal and the first node, and is configured to reset the driving transistor, the energy storage sub-circuit and the voltage maintenance sub-circuit in a reset phase responsive to a reset compensation control signal provided by the reset compensation control terminal, and perform threshold voltage compensation on the driving transistor in a threshold compensation phase.

2. The pixel driving circuit according to claim 1,
wherein the reset compensation control sub-circuit comprises a reset transistor and a compensation transistor, and the reset compensation control terminal comprises a reset control terminal and a compensation control terminal,
wherein a control terminal of the reset transistor is connected to the reset control terminal, a first terminal of the reset transistor is connected to the first node, and a second terminal of the reset transistor is connected to the reference level input terminal, and
wherein a control terminal of the compensation transistor is connected to the compensation control terminal, a first terminal of the compensation transistor is connected to the fourth node, and a second terminal of the compensation transistor is connected to the third node.

3. The pixel driving circuit according to claim 2, wherein the reset transistor and the compensation transistor are of a same type, and the reset control terminal and the compensation control terminal are connected to a same signal terminal.

4. The pixel driving circuit according to claim 1,
wherein the data writing sub-circuit comprises a writing control transistor,
wherein a control terminal of the writing control transistor is connected to the scan signal input terminal, a first terminal of the writing control transistor is connected to the fourth node, and a second terminal of the writing control transistor is connected to the data signal input terminal.

5. The pixel driving circuit according to claim 1, wherein the power supply control sub-circuit comprises a power supply control transistor, a control terminal of the power supply control transistor is connected to the power supply control terminal, a first terminal of the power supply control transistor is connected to the third node, and a second terminal of the power supply control transistor is connected to the power supply signal input terminal.

6. The pixel driving circuit according to claim 1,
wherein the energy storage sub-circuit comprises an energy storage capacitor, and
wherein a first end of the energy storage capacitor is connected to the first node, and a second end of the energy storage capacitor is connected to the fourth node.

7. The pixel driving circuit according to claim 1,
wherein the voltage maintenance sub-circuit comprises a voltage stabilization capacitor, and
wherein a first end of the voltage stabilization capacitor is connected to the first level input terminal, and a second end of the voltage stabilization capacitor is connected to the fourth node.

8. The pixel driving circuit according to claim 1, further comprising:
a light emission control sub-circuit,
wherein the light emission control sub-circuit is connected to a light emission control terminal, the second node and a second level input terminal, respectively, and configured to ensure that the light emitting sub-circuit emits light in a light emitting phase responsive to a light emission control signal provided by the light emission control terminal.

9. The pixel driving circuit according to claim 8,
wherein the light emission control sub-circuit comprises a light emission control transistor, and
wherein a control terminal of the light emission control transistor is connected to the light emission control terminal, a first terminal of the light emission control transistor is connected to the second level input terminal, and a second terminal of the light emission control transistor is connected to the first terminal of the driving transistor.

10. The pixel driving circuit according to claim 1,
wherein the light emitting sub-circuit comprises a light emitting device, and
wherein an anode of the light emitting device is connected to the first terminal of the driving transistor, and a cathode of the light emitting device is connected to the second level input terminal.

11. A driving method for a pixel driving circuit according to claim 1, wherein a display period comprises a reset phase, a threshold compensation phase, a data writing phase, and a light emitting phase, wherein the driving method comprises:
in the reset phase, releasing, by the reset compensation control sub-circuit, residual charges in the energy storage sub-circuit and the voltage maintenance sub-circuit, and turning on the driving transistor;
in the threshold compensation phase, discharging the driving transistor by the reset compensation sub-circuit, and storing the threshold voltage of the driving transistor in the energy storage sub-circuit;
in the data writing phase, writing, by the data writing sub-circuit, a data signal to the energy storage sub-circuit; and
in the light emitting phase, driving, by the driving transistor, the light emitting sub-circuit to emit light.

12. The driving method for a pixel driving circuit according to claim 11, wherein the pixel driving circuit further comprises a light emission control sub-circuit, wherein the light emission control sub-circuit is connected to a light emission control terminal, the second node and a second level input terminal, respectively, and configured to ensure that the light emitting sub-circuit emits light in the light emitting phase responsive to a light emission control signal provided by the light emission control terminal, the driving method further comprising:
ensuring, by the light emission control sub-circuit, that the light emitting sub-circuit does not emit light in at least one of the reset phase, the threshold compensation phase, and the data writing phase.

13. The driving method for a pixel driving circuit according to claim 11, the display period further comprising a first buffer phase between the threshold compensation phase and the data writing phase.

14. The driving method for a pixel driving circuit according to claim 11, the display period further comprising a second buffer phase between the data writing phase and the light emitting phase.

15. A display device comprising the pixel driving circuit according to claim 1.

16. The display device according to claim 15,
wherein the reset compensation control sub-circuit comprises a reset transistor and a compensation transistor, and the reset compensation control terminal comprises a reset control terminal and a compensation control terminal,
wherein a control terminal of the reset transistor is connected to the reset control terminal, a first terminal of the reset transistor is connected to the first node, and a second terminal of the reset transistor is connected to the reference level input terminal, and
wherein a control terminal of the compensation transistor is connected to the compensation control terminal, a first terminal of the compensation transistor is connected to the fourth node, and a second terminal of the compensation transistor is connected to the third node.

17. The display device according to claim 16, wherein the reset transistor and the compensation transistor are of a same type, and the reset control terminal and the compensation control terminal are connected to a same signal terminal.

18. The display device according to claim 15,
wherein the data writing sub-circuit comprises a writing control transistor,
wherein a control terminal of the writing control transistor is connected to the scan signal input terminal, a first terminal of the writing control transistor is connected to the fourth node, and a second terminal of the writing control transistor is connected to the data signal input terminal.

19. The display device according to claim 15,
wherein the power supply control sub-circuit comprises a power supply control transistor,
wherein a control terminal of the power supply control transistor is connected to the power supply control terminal, a first terminal of the power supply control transistor is connected to the third node, and a second terminal of the power supply control transistor is connected to the power supply signal input terminal.

20. The display device according to claim 15,
wherein the energy storage sub-circuit comprises an energy storage capacitor, and
wherein a first end of the energy storage capacitor is connected to the first node, and a second end of the energy storage capacitor is connected to the fourth node.
